(19) United States
(12) Patent Application Publication
(10) Pub. No.: US 2004/0018036 A1
(43) Pub. Date: Jan. 29, 2004

(54) Writing untensil with single-piece mechanical component

(76) Inventor: Siegbert Vial, Burgwald (DE)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/363,073

(22) PCT Filed: Aug. 31, 2001
(86) PCT No.: PCT/DE01/03347

(30) Foreign Application Priority Data
Sep. 1, 2000 (DE) 100432190
Dec. 22, 2000 (DE) 10064176.8

(51) Int. Cl. B43K 5/16; B43K 24/02

(52) U.S. Cl. 401/112; 401/111; 401/110

(57) ABSTRACT

There is suggested a writing instrument having a shaft (9) and a push member (K,L;10) especially formed in one piece, which push member comprises a push portion (L), a body portion (K,50) and a switch rod portion (S) extending from the body portion in the axial direction and comprising a switch tooth (Z) protruding radially therefrom, which switch tooth (Z) is displaced within shaft (9) by at least one small segment (A,B) of shaft (9), being reshaped in the radial direction, upon actuation of the push member (10) in particular in the circumferential, tangential and/or radial directions; or which comprises two axially spaced apart stable positions corresponding to the writing position and the retracted position of the writing instrument, wherein switch tooth (Z), in both positions, assumes the same at least circumferential (tangential) position only axially displaced; or which is arranged on the switch rod portion in such a manner and has such a circumferential (tangential) extension (z6,z2) and shape that a center plane (70), extending in parallel with the center axis (100) of the push member, lies at an axially front end portion (z3, z1) as well as an axially rear end portion (z7) of switch tooth (Z) within the switch tooth. The invention provides a one-piece mechanics in combination with a substantially one-piece shaft (at least in the rear portion thereof, which can be produced at low cost, guarantees functional safety and uses as few parts to be assembled as possible.

The invention is concerned with a number of (independent) inventions relating to one-piece (integral) mechanics of writing instruments. The respective independent claims characterize the technical field regarding the introductory words of the respective independent claims so that reference is made thereto.

From the prior art EP 388 632 B1 (Merz & Krell) a two-piece writing instrument is “known” comprising a one-piece push button device, which is made of a uniform material in one piece and includes a one-piece shaft. The third part (the refill) is not mentioned separately. The push button device comprises no further mechanically moveable parts but only an elastically deflectable switch rod supporting a switch tooth as a switching element, which cooperates with recesses as guide curves provided on the shaft. It is the core of this design to reach the two shift positions, the writing and idle positions (the axially forward and axially retracted positions), and to latch and unlatch, respectively, the writing instrument in the respective positions with respect to the refill. In order to improve accuracy of the switching processes a post, which is denoted in said document as such (reference numeral 24 therein), is provided allowing the switch rod to perform more accurate switching movements upon latching or unlatching movements. The push button device is inserted into the rear portion of the shaft from above and is non-rotatably retained within the shaft by a separate guide means. The push button device does not comprise any moveable parts but only said elastically deflectable switch rod, which is moved substantially in the one plane for the latching movement and is moved substantially in a plane perpendicular thereto for the unlatching movement. The planes are defined by a post having two edges with respect to boundary planes, which post is arranged on the switch rod of the push button device. Upon the latching movement the post limits the movement of the switch rod in the radial inward direction so that the switch tooth cannot slide out of the switch groove (the control curve portion). Upon the return stroke movement, i.e. the unlatching movement, the post limits the circumferential or tangential back displacement of the switch tooth (depressing, letting go and moving back the push button device) so that the switch tooth is not latched again in the undercut provided for the writing position, which it is supposed to leave.

Writing instruments according to the mentioned prior art are extremely robust and can be produced at low cost. They are trouble-free due to the lack of moveable parts and permit production of highest numbers at minimum prices due to the one-piece mechanics and the shaft per se in the sense of “two-piece writing instruments” (plus the refill). The technical and economic development demands, however, that prices must be further reduced also in the future and that therefore production methods must be simplified and production costs reduced without influencing the functional safety of the writing instruments. At best said functional safety is to be improved even further by using low-price plastic materials and utilizing low-cost production methods.

The technical problem of the invention is therefore to create a one-piece mechanics in combination with a substantially one-piece shaft (at least in the rear portion thereof), which can be produced at low cost, guarantees functional safety and uses as few parts to be assembled as possible. Nevertheless replacement of the refill is to be possible—in order to maintain the writing ability of the writing instrument—i.e. disassembly of the mechanics is to be possible, so that the user of the writing instrument may replace the refill in case it should be used up one time.

The independent claims offer the solution to the above-mentioned problem in view of a shaft, a writing instrument or a push button device, which can be inserted into the shaft (claims 1 and 10, claims 15, 35 and 36, claims 20, 23, 30 and 37).

On the one hand, the low-cost production method is achieved by realizing the one-piece mechanics by means of a uniform push button device, which may be produced in a low-cost production method by means of a low-cost tool. It can easily be removed from said tool (mold) not comprising any complicated mold cavities (claim 20). The separation of the mold halves required for said part is a single plane so that the injection molding die may be kept “simple”.

By using low-price plastic materials having low inherent elasticity and high resilience it is made sure that the switch rod, on the rear end of which the switching element (in particular as the switch tooth) is arranged, undergoes no radial displacement in the writing position relative to the idle position, and in particular no substantial tangential displacement (or circumferential displacement—with a shaft sleeve having a round cross-section) (claim 30). However, an axial displacement of the push member is used for switching purposes. The switch rod is therefore not subject to fatigue. The post, required in the prior art, can be omitted and functional safety of the writing instrument can nevertheless be ensured.

If there is a lack of tangential (circumferential) deflection of the rod in the writing position relative to the idle position, no inherent elasticity must be provided or bending moments accepted on the long term, but the switch tooth is located in the same circumferential or tangential position in each of the two stable conditions, the first shift position and the second shift position (as the writing position and the idle position).

The same applies to the radial position, which in the writing position does not deviate from the idle position, neither inwards nor radially outwards, with respect to a circumferential cylindrical shape of the shaft. Here no permanent forces either must be provided while retaining the elasticity of the switch rod.

The writing instrument distinguishes itself on the one hand with regard to the push button device and on the other hand also with respect to the shaft by the fact that the respective parts are designed such that the switch tooth, in the writing position relative to the idle position or vice versa, undergoes an axial displacement only and virtually no or none at all tangential (circumferential) displacement as well as virtually no (or none at all) radial displacement (claim 15). Independent therefrom is the sequence of movements between the two stationary positions, the idle position and the writing position. Between those two movements the corresponding deflections are provided in the tangential (circumferential) and radial directions or one of said two components of motion respectively for moving the switch tooth from one stable position into the second stable position or vice versa.

Also serving the purpose of low-cost production is the design of the one-piece shaft, also as a shaft portion, at least in that region, in which the two stable positions of the writing instrument are located, which are caused by the corresponding latched positions of the switching element on the switch rod at the push member. This region is located in the rear portion of the shaft, especially in the last third to fourth of the length of the shaft of a modern writing instrument. In this shaft, which is preferably made of metal, which however may also be made of a permanently shapeable, bendable and infrangible plastic material (claim 35), at least one small shaft segment is provided, which is radially reshaped or deformed in order to define at least one portion of a control curve (claim 1, claim 10).

The deformation is effected relative to the shaft, i.e. radially inwards or radially outwards. It is preferably located in the region below a clip, which is integrally formed at the push button device.

The radial deformation is effected along a region of deformation, which may be designed as a deformation line, inflexion line or bending line. Additional parts, inserts or attachment parts are not required (claim 31). The control segments (called shaft segments due to their origin) formed from the shaft material in the radial direction define those switch curve portions, along which the switching element is elastically deflected at the switch rod in the radial direction or circumferential (tangential) direction, depending on the time of the movement or (axial) location of the push button device or switching condition of the writing instrument (claim 12).

Due to the deformation it may be possible that with certain materials or certain geometries the bending lines become separating lines, wherein the shaped shaft segment is given a free edge protruding separated from the shaft in the radial direction (inwards or outwards) in order to serve as a stop or guide line for the switching element (claim 3).

Those edges, which lead to a separation in the sense of a cutting exceeding the extent of a bend, inflexion or deformation, are preferably oriented thither where no extended gliding abutment of the switching element is provided, which is usually made of plastic material, to prevent abrasion changing the shape of the switching element. The conditions of formation of burrs during the reshaping or cutting process are taken into account accordingly (claim 9).

The use of a metallic material for the shaft (claim 6) ensures reliable provision of the segments formed in or on the shaft for controlling the switch tooth of the switch rod (claim 35). The push member, which is inserted into the back of the shaft, at least in the lower region of the switch rod (the switch rod foot connecting the switch rod to the residual push button device), may be formed of a material providing torsion or elastic deflection, wherein in particular the entire push button device (claim 36) including the switch rod is formed of the same material in one continuous piece. A plastic material providing elasticity in the foot portion of the switch rod is suitable for this purpose.

This writing instrument may be provided with reshaped segments of the shaft, wherein also non-metallic materials may be used for the shaft approaching the property of the metallic material, i.e. allowing bending (without breaking) and which may be permanently reshaped in the segment region.

Finally, the invention also involves the problem of achieving a refill replacement while maintaining ease of handling. Replacement of the refill is not easy to achieve in a writing instrument having a one-piece mechanics member (push member) and, in addition, a one-piece shaft portion in the switch curve portion of the shaft, since (rotating, gliding or sliding) moveable additional parts had to be avoided on the push button. The one-piece push member must thus be accommodated and guided within in the shaft in such a manner that, despite of the accommodation and guidance, removal of the push member from the shaft and reinsertion with continued function will be possible. This is achieved by the invention (claim 23) in that a limited guide element, which is arranged on the push member between a stationary arranged guide portion and said switch rod, yields elastically due to a relative rotating movement of the push member.

Due to the character of its surface it is possible to circumferentially rotate the push member (or the shaft relative to the push member), wherein the elastically resilient guide element of the push member yields radially and is released from associated axial guide segments. The push member may then be removed—axially backwards subsequent to the circumferential rotation and the refill be replaced. The positive thing about this is that the switch rod comes out of or leaves, respectively, the sphere of influence of the guide segments by means of the circumferential rotation and that the push member may be axially removed from the shaft without any interlocking of the switch tooth.

Reinsertion of the push member in turn is effected under the influence of the elastic resilience of said guide element on the push member also in the radial direction, even though the forces required for insertion are provided herein by an axial movement, wherein the guide element is oriented in a circumferentially matching manner towards the axial guide segments.

Releasing the push member is thus effected by a limited circumferential movement while reinsertion of the push member into the guide is effected by means of an axial pressure component.

The invention will be explained in greater detail hereinafter, by way of example, with reference to the drawings.

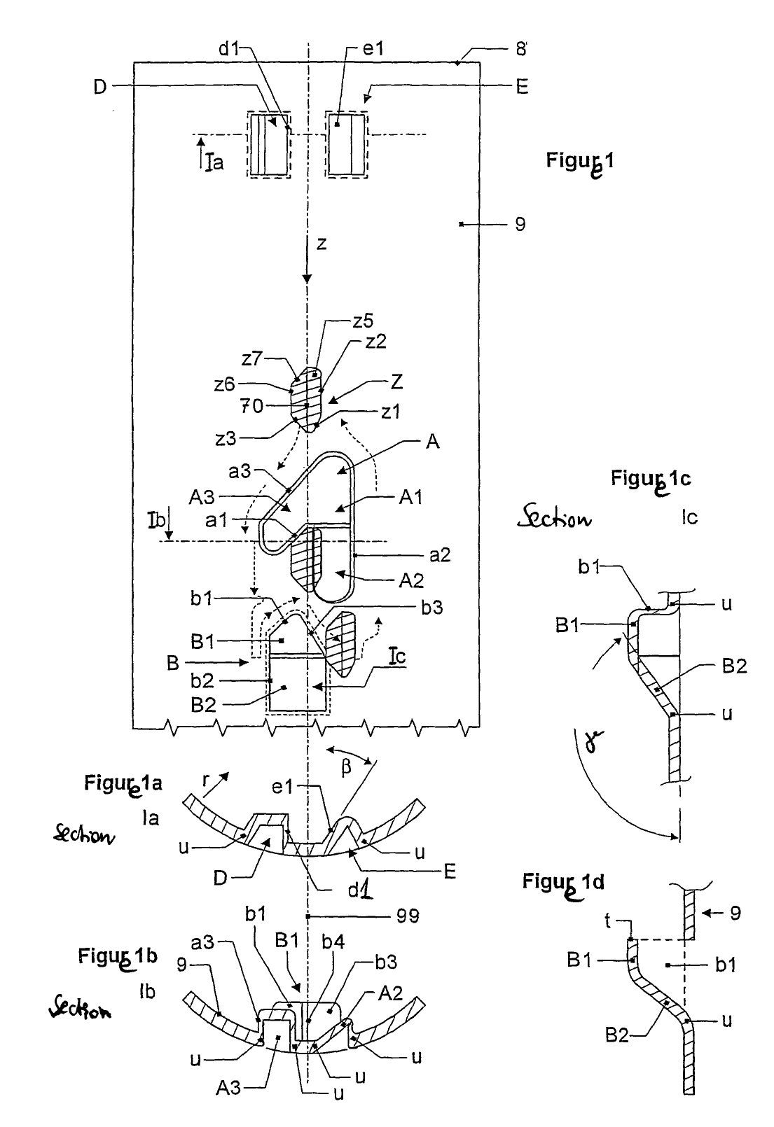

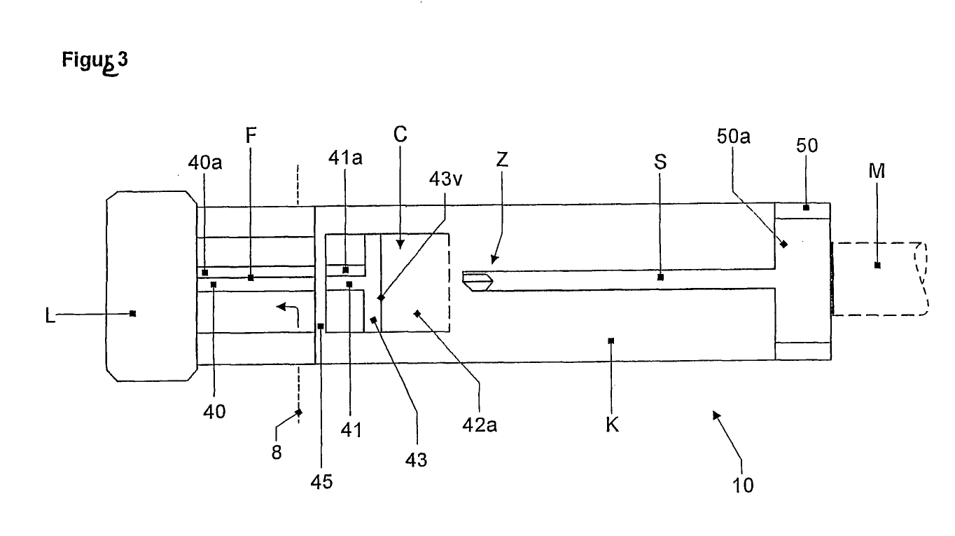

FIG. 1 is a plan view of the upper portion of a shaft 9, the upper edge 8 of which is visible, whereas the lower portion of the shaft in the direction towards the residual writing instrument is not illustrated herein. In this respect it is referred to FIG. 4.

FIG. 1a is a sectional view taken along a plane perpendicular to axis 99 of shaft of FIG. 1. The section is taken along intersection line 1a indicated in FIG. 1.

FIG. 1b is a sectional view of FIG. 1 taken along line 1b indicated in FIG. 1, wherein only that portion of the cylindrical shaft is shown, in which the reshaped shaft segments A, B of FIG. 1 are provided.

FIG. 1c is a sectional view taken along a plane in parallel with axis 99 level with segment B of FIG. 1, as indicated therein by 1c.

FIG. 1d is a sectional view taken in same location as in FIG. 1c, only that here an upper deformation line b1 is provided as a separating line t, which is separate from the residual shaft 9.

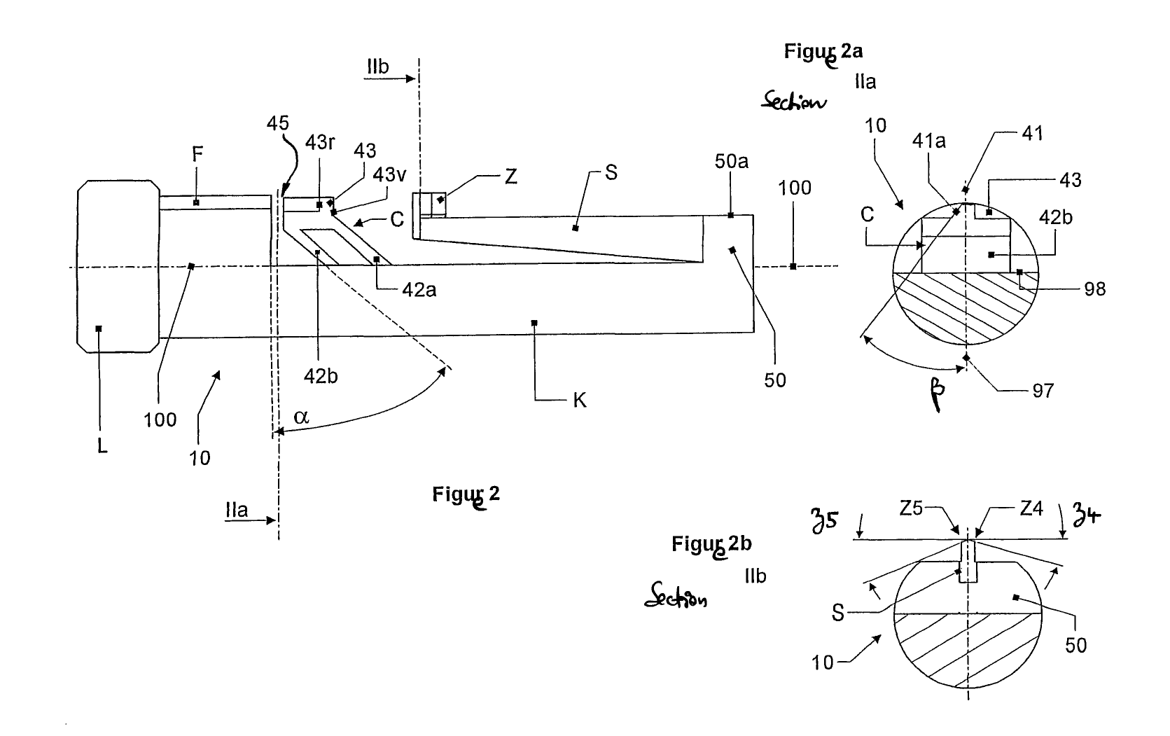

FIG. 2 is a side view of a push member 10, which is provided at the upper end of the shaft in FIG. 4, partially above and below the upper edge 8. There is illustrated a side view, from which the switch tooth Z and the push button head L are apparent.

FIG. 2a is a sectional view perpendicular to axis 100 of the push button device taken along plane 11a of FIG. 2. The two perpendicularly oriented center planes 97, 98 of the push member 10 are evident therein.

FIG. 2b is a sectional view taken along line 11b of FIG. 2, namely through switch tooth Z located on a switch rod S in a direction perpendicular to axis 100 of FIG. 2.

FIG. 3 is a plan view of the push member 10 of FIG. 2, wherein switch rod S, switch tooth Z as well as an elastically supported function element C are evident. The refill M is outlined, which abuts the front end of the push member 10 supported by a spring (not shown) located in the front portion close to the front aperture of the writing instrument of FIG. 4.

FIG. 4 is a schematic side view of the writing instrument comprising a metal shaft 9 herein, the push member 10 inserted at the back as well as a refill portion of refill M emerging at the front in the writing position. The shaft 9 is tapered in the region 9a towards the aperture for the refill.

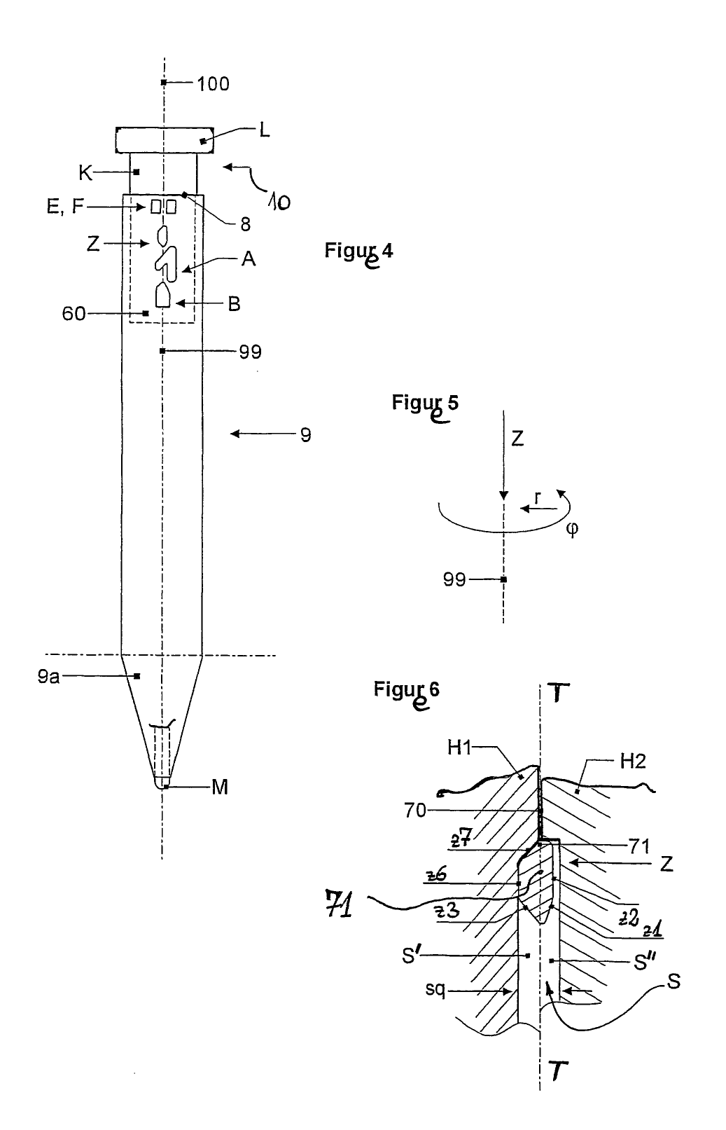

FIG. 5 is an illustration for explaining the used coordinates r, φ and z.

FIG. 6 is an illustration of switch tooth Z of FIG. 2 or 1 in a position between two mold halves H1, H2 upon injection molding of push member 10.

Proceeding from FIG. 4, in which a writing instrument comprising a refill is illustrated, which may be a ball-point, a roller ball or other writing instrument having a shaft and a push member, various functional portions of this writing instrument are to be described with reference to FIGS. 1 to 3. FIG. 4 is intended to give a general view. The rear push member 10 comprises a push portion L and a body portion K. Body portion K is inserted into the upper end of shaft 9 and is retained axially moveable therein. Axis 99 of shaft 9 coincides with axis 100 of push member 10. This direction is supposed to be the axial direction, also denoted by z, oriented at the cylinder coordinates, as evident from FIG. 5.

The front portion of shaft 9 is portion 9a. In this portion the writing instrument is tapered and comprises a front outlet aperture for moving the refill M out into a writing position and for retracting the refill into an idle position, in which no refill portion emerges at the front. This corresponds to the position of push member 10 in a forward position (writing position) and an axially backwards displaced position (retracted position). The shaft is elongate and includes a switch curve control in its rear portion and a guide for the push member which will be explained in more detail with reference to the residual Figures. It is to be understood that a spring arrangement or at least an elastic arrangement is provided within the writing instrument, which is capable of applying a backwards oriented force onto push member 10 so that it may be moved against this switching pressure, wherein the mentioned switch curves will have their effect with respect to latching and unlatching, namely upon movement from the idle position into the writing position via intermediate positions and upon release from the writing position in the course of the return movement to the idle position located further backwards, in which the refill is not extended.

The shaft shown is made of metal. It may also be made of other materials, such as hard plastic materials or other permanently shapeable materials. Push member 10 is made of any appropriate material, usually of a plastic material, which will be explained in more detail with reference to FIGS. 2 and 3. The illustrated control curve portions as well as switch tooth Z cooperating therewith, which switch tooth is located on a switch rod S shown in FIGS. 2, 3, define the control of the switching device via pressure forces acting on the push member 10.

For realizing the switch curves the control curve portions are shaped out of the shaft. The control curves are apparent from FIG. 1. A first segment A is illustrated therein, which comprises three portions A1, A2 and A3. A second segment B comprises two portions B1, B2. Those two segments will be called shaft segments hereinafter. Guide segments E and F are provided at the upper rim portion close to the upper edge 8 of the writing instrument. Those elements are also parts of the shaft as small segments having been shaped out of the shaft.

Segments A, B, E and F are shaped from the material of the shaft, e.g. in a cutting method or a bending method or a combined cutting and bending method in one single operation. No waste is produced in this method and openings are produced on the shaft simultaneously with forming the segments, which shaft is made of a permanently shapeable material. The inward protuberance in the radial direction or the outward protuberance in the radial direction with respect to the residual shaft portion creates links, lines or surfaces, along which the mentioned switch tooth Z may slide in order to be deflected and to arrive at corresponding guide tracks, undercuts and deflection paths. These are called control curve portions.

Upon forming (reshaping, deforming or bending) segments A, B, E, F transition zones as regions of deformation u are created, in which the radially reshaped segment passes over into the residual non-deformed shaft 9. Those regions may comprise bending or inflexion lines, they may also have continuous curvatures, so that the radially oriented deformation of the respective shaft segments is effected at least along said region of deformation. Thus control curve portions protruding radially from the shaft are created, which will be described hereinafter. They extend at least in the axial direction, of course, also in the radial direction and at appropriate locations in the tangential or circumferential direction for deflecting the switch tooth in its axial stroke.

By that means it is to be determined that the cylinder coordinates for describing the switching processes will be used. It is to be understood that the three-dimensional movement of a switch tooth during the switching movement will not always and unambiguously take place within the cylinder coordinates only, but will rather perform combined movements comprised of at least two or all three components of a cylindrical system of coordinates, which is apparent from FIG. 5. The axial direction is z. The radial direction (perpendicular to the axial direction) is r, inwards as well as radially outwards. The circumferential direction is φ. Upon actuation of the switch tooth, on the basis of which the switching travel may be assessed, also combined movements of the three components may occur, e.g. a tangential movement, which is a combination of components r and φ. The tangential and circumferential movements are usually denoted identical in the description, since the tangential moving distance is normally short and thus extends circumferentially in a first order approximation.

However, it is also possible that the writing instrument is flattened in that part of the shaft in which the control curve portions are arranged so that the movement of the switch tooth taking place along this surface (perpendicular to the z direction) is a combination of components r and φ.

The radial reshaping of the shaft segments ensures that segments A1, A2, A3 as well as B1 and B2 as control segments for the switch tooth are made of the same material as the shaft. This is the consequence of the mechanical processing and the shaft as the starting object.

On two axially spaced apart shaft segments, a plurality of curve portions is defined cooperating with switch tooth Z at different times. Distinguished therefrom are the axially more remote shaft portions D and E located close to the upper edge 8 of the shaft, which portions are to be considered different with regard to function and which are allotted a guide function along a link portion 40 of the push member, which is shown in FIG. 2 and FIG. 3. No deflecting influences are acting on the switch tooth here but the push member is guided in an axially oriented direction in such a manner that it is blocked against a stronger circumferential movement. Nevertheless said shaft portions D and E are also made of the same material as shaft 9. They are located above the switch curves between the normal idle position of switch tooth Z and the upper end 8 of shaft 9. The entire portion between the upper edge 8 and the lower end of the switch curves is less than a third, in particular less than a fourth, of the length of shaft 9.

The configuration of the shaft segments for forming switch curves or at least switch curve portions requires a deformation of segments of the shaft. The shaft must thus be sufficiently plastically shapeable at least in those portions being shaped. The shaft suitable for deep-drawing to this extent is preferably made of metal and the processing method is preferably a combined cutting and bending method. During cutting burrs are created, namely on the side facing the die (male mold). In the embodiment the reshaping is effected radially inwards, i.e. by means of an internal counter-die or female mold and a male mold acting from outside reshaping a small portion of the shaft radially inwards thus creating a burr, which, upon partial separation of the radially inwards deformed segment, is located on the side of the segment facing the male mold. If separation can be avoided due to a high deep-drawing ability of the shaft material, i.e. a high apparent yielding point, no burrs at all are created and all shaped formations are provided with rounded edges or lines suitable for guiding switch tooth Z, without wearing it off or damaging it during movement.

In most cases, however, it cannot be prevented that the one or other line of deformation becomes a separating line t, as shown in FIG. 1d. Even before creation of separating line t a bending line b1 can be observed, which does not comprise any separation of the region of deformation u. In this respect the second shaft segment B comprised of portions B1 and B2 is illustrated, as shown in FIG. 1. Lines b1 and b3, which are separated in the example shown in FIG. 1d, follow a kink of a curve, which is only partially required for the switching operation upon axial actuation of switch tooth Z so that separating line t at least in location b1 is harmless for the switching operation and for maintaining of the shape and function of switch tooth Z. With respect to line b3 there is, however, the possibility that the switch tooth abuts said line in a contacting manner upon movement in the course of the return movement from the writing position into the idle position so that wear may occur here and care must be taken during reshaping that said line b3 is not provided with a burr so that the design according to FIG. 1c is preferred herein.

Accordingly, all edge lines of the shaped segments, which will be explained in greater detail hereinafter, are designed such that they are possibly not configured as separating line t, but as bending line b1, when the switch tooth slidingly abuts them under pressure over a greater distance, without creation of a burr when shaped from the shaft.

The following description is intended to explain, with reference to FIG. 1 and the associated sectional views of FIGS. 1a, 1b and 1c (analogously equivalent to FIG. 1d), how the radially reshaped segments cooperate with switch tooth Z. For this purpose firstly the switching operation as such will be explained, which allows a general view on the movement of the switch tooth.

The switching movement starts in the idle position where switch tooth Z lies within the center plane (through axis 99). Switch tooth Z comprises a plurality of stop edges or stop face portions zₓ (x=1, 2, . . . 7) creating a certain geometry, which is more apparent from the drawing, said geometry providing switch tooth Z with a greater extension in the longitudinal direction than in the tangential or circumferential direction. The switch tooth may be described as substantially oblong oval, wherein the stop faces always include portions of planes so that a non-symmetrical polygon is created in the lateral cross-section.

Starting from the initial position, which is the idle position, in which refill M does not protrude from the writing instrument and the elastic spring within the writing instrument is relaxed to its maximum, the switch tooth is moved axially forward upon actuation of push button device 10 until the first stop face z1 meets deformation line a3. Switch tooth Z is then deflected circumferentially since the push button device as such is guided within segments D and E and is not subject to rotation within the shaft.

Upon further axial advance switch tooth Z reaches the end of inclined line a3 and falls toward second segment A2 in the circumferential direction. However, it will not reach said segment but contact control line b1 of second segment B or its front portion B1, respectively, with its stop face z1 in a position, which is not shown. The switch tooth is thus still kept on the left-hand side of the center plane and will not yet fall into the operating position inside the v-shaped first segment A defining the writing position. This is useful since a user will not terminate actuation at the point of leaving a3, but will usually axially depress the push button device to its full extent so that line b1 as well as extension b2 of said line b1 will still contribute to the actuation each with respect to stop face z1 of tooth Z. Both line portions b1, b2 and b1, b3 are buckled.

Only when letting go the push button device the tooth slides backwards along the dashed path and falls—controlled by line b1—into the v of line a1, which is open downwards, and along segment A2 which is designed as an inclined surface. This is the second stationary position or writing position. Tooth Z is neither radially nor tangentially deflected relative to the initial position, i.e. the idle position, it is thus virtually in the same position except for an axial displacement. There is no need for switch rod S to provide any forces here, neither in the retracted position nor in the writing position. In both cases the switch tooth lies within the center plane.

In the temporal actuating portion of the return movement, said movement starts with an advance in the axial direction z. The user will depress push portion L again and switch tooth Z will move along plane A2 of the first shaped shaft segment with a radially upper stop face z5 (apparent from FIG. 2b). Thereby the switch tooth receives a radially inwards directed component of motion caused by guide surface z3 and stop line b3 on second segment B or its first portion B1, respectively. It moves along the dashed path circumferentially farther to the right while simultaneously performing a radially inwards directed movement.

After leaving segment A2 stop face z7 is given its task upon retraction and slides along the beginning of line a2 which should be configured as deformation line u, but may also be a separating line t according to FIG. 1d. The switch tooth can be deflected farther to the right and moves along the dashed path, wherein stop face z6 contacts control curve portion a2 extending in the axial direction until it again reaches its initial position. Said position is substantially displaced in the circumferential direction relative to return line a2.

First segment A comprising the three portions A1, A2 and A3 is substantially v-shaped with its opening facing downwards (towards the writing tip). Second segment B1, B2, in total B, is roughly triangular in its first portion B1. Both segments are located on the one side as well as on the other side of the center plane, wherein the triangular orientation of the second segment with its first portion B1 points to the opening of the v-shaped first segment.

Second segment B may additionally comprise a support portion B2 which is inwardly inclined, as is apparent from FIG. 1c. Said portion is continued by the substantially circumferentially oriented first segment B1, which is limited either by a deformation line b1 according to FIG. 1c or a separation line t according to FIG. 1d.

The second segment B has a greater depth, as is apparent from FIG. 1b. An axial view in accordance with section 1b is shown therein. The one arm A3 of the first segment A and the shaped formation of the second arm A2, A3 of the first segment A as the inclined surface A2 are apparent therefrom. The second segment with its first portion B1, which is formed to a greater depth, is visible directly behind, the front tip b4 of which can be recognized as the end of the triangular shape, wherein the buckled front b4 separates the two control portions b1 and b3. Those portions, when configured as separating line t, become stop lines cooperating with the two control surfaces z1 and z3 of switch tooth Z located at its front end.

It is apparent from FIG. 1b which regions are provided as deformations lines u. The initial inclined control line a3 on portion A3 of the first segment A is also evident therefrom.

Stop line al is not a sliding edge but only an edge which switch tooth Z abuts with its control surface z7 in order to reach the writing position. It may easily be designed as separating line t. The beginning of slope A2 is in any case designed as deformation line u, since the switch tooth must plunge here slidingly in the radial direction. The configuration of the switch tooth at its upper end having two slopes is beneficial for this movement, which is apparent from FIG. 2b. The two inclined portions z5 and z4 illustrated therein cooperate with the interior surface of shaft 9 in the example shown as well as in the beginning of the axial downward movement along line a3, wherein the top surface z4 as the wider surface also applies a radial component of motion onto the switch tooth while it is circumferentially and tangentially deflected.

Hence follows that the modules of elasticity of the two components of motion should be different for switch rod S. The tangential rigidity should be less than the radial one. Nevertheless a radial resilience should be present in order to maintain the movement along control line a3 and along switch face A2. However, it cannot be avoided that, in a tangential (circumferential) deflection of the switch tooth, also a radial component is provided by the design of the shaft which is cylindrical in this portion. In case the shaft is completely flat here, i.e. having a flat portion formed into the barrel extending along the cylindrical portion, formation z4 could be omitted, since switch tooth Z would then only perform a planar movement for moving along a3, which planar movement is, however, comprised of a circumferential and a radial component shown in the representation of components, even though no actual radial plunging movement will occur in this portion.

The position of switch tooth Z in the writing position and in the idle position has already been discussed. It is determined such that switch rod S is not substantially deflected, neither radially nor tangentially, in the writing position relative to the idle position. It is thus not subject to fatigue and no additional measures are required for securing the switch rod in order to provide the switch tooth with a precisely predefined switching path. Such safety measures are the initially described “post” on the shift body K of the push member, which defines the boundary planes for the switch rod movement. Due to the lack of elastic deflection in the retracted position and in the writing position no enhanced modules of elasticity or cost-intensive plastic materials need to be employed, rather also low-cost plastic materials may be used, without requiring any additional control measures for the switching accuracy. Both measures reduce costs of the push member, which can be produced at low cost anyway in one single injection molding process due to its one-piece design (made in one piece or integrally) and which further does not comprise any mechanically moveable parts except for the elastically bendable rod, which is not considered as a moveable part in this sense but as an elastically deflectable control element comprising said switch tooth Z at its rear end.

Shaft segments E and D have already been described in the beginning. They are also made of the same material as shaft 9. They are illustrated in FIG. 1a, in which also their geometrical shape can be seen in the sectional view along plane 1a. Shaft segment D shown on the left-hand side of FIG. 1 comprises an inner stop line or stop face d1, which may be configured as deformation line u or as separation line t according to FIGS. 1c or 1d. The juxtaposed shaft segment E has a different design. It comprises a leading slope e1 and two regions of deformation u, none of which is at best a separating line t. The leading slope e1 should not comprise a separating line t.

Said two shaped formations cooperate with a mechanics shown in FIG. 2, which is comprised of an elastically resilient latching element C and an elastically non-resilient or only slightly resilient guide element F. Those two portions are illustrated more clearly in the plan view of FIG. 3. Between said two portions F and C there is a gap 45 so that latching element C is elastically resilient relative to body K at two linking webs 42a, 42b extending inclined at an angle α, caused by radial forces, while guide portion F with its link 40 is non-resilient relative to body K.

When inserted, the push button device is located with all its elements on the right-hand side of gap 45 and with one part on the left-hand side of said gap within shaft 9 below edge 8 of FIG. 1. In such an inserted position, the elastically resilient latching element C is located with a guide link 41, which is a prolongation of the non-resilient guide link 40, between the two shaped formations D and E according to FIG. 1a. On the one hand, a circumferential barrier is thus provided for axial guidance if axial actuating forces are present; on the other hand, guide link 41 may be moved radially inwardly from inclined surface e1 of the shaft when rotating the push member 10 relative to the shaft due to the elastic resilience of the two links 42, 42b. Member 10, together with link 41, may thus be released from an axially guided seat by means of rotation due to its surface structure; it is, however, in the inserted position, guided axially at the same time for the normal actuating movements of push member 10.

It should be noted that a preferred direction may be predetermined, e.g. by the described inclined surface e1 and a correspondingly configured ramp 41a on the one side of link 41 of the elastically resilient latching element C. This asymmetry can be seen in FIG. 2a as well as in FIG. 3. FIG. 2a is a section taken along plane IIa of FIG. 2 and shows that inclined surface 41a facing towards the left-hand side cooperates with inclined surface e1 illustrated on the right-hand side in FIG. 1 for ease of application of radially inwards directed forces onto latching element C upon circumferential rotation of the push button device by a small angular measure.

The corresponding configuration of the release action by means of circumferential rotation may be achieved by changing the inclined surfaces by defining only one inclined surface e1 or 41a. It may also be the case that an inclined surface is provided on both sides in order to configure surface d1, which at first only defined a stop and guide line, also as a release ramp in accordance with plane el. In view of the given description, the modifications according to FIGS. 2a and 1a are easily comprehensible for a person skilled in the art in the sense of a solution favoring one side (in the one or other circumferential direction) or in the sense of a solution favoring two-sides.

It is advantageous if the user is constrained to a left-hand movement (when viewing the writing instrument from behind) since he is used to release threaded joints by a left-hand movement so that the direction of release provided by the slope e1, as shown in FIG. 1, is the one which is ergonomically favorable. However, this does not exclude that the other described directions of release also feasible.

Release (removal) basically entails reinsertion (insertion), since push member 10 is an element which may be used again and again even if the refill has been replaced subsequent to a release and removal of the push button device. For this purpose the push member is inserted in the axial direction.

Upon insertion a radially oriented force is applied on the elastically resilient latching element C by means of the axial movement. This force acts on the front link 43 via its front edge 43v, wherein the link as such should have a substantially round shape in order to match the shape of the cylindrical writing shaft. Firstly, edge 8 and then the axially free edges of segments E, D abut edge 43v. By means of an axial pressure component the elastically resilient latching element C is pressed downwards (inwards) in the radial direction and releases edge 43v from the rear edges of segments E, D so that latching and engaging of guide segments D and E at guide link 41 of the elastically supported latching element C becomes possible. A further axial actuation leads to the fact that also link 40 of the non-resilient guide element F is received between shaft segments D and E, wherein the elastically resilient element C is then freed from said segments E, D and is located in front of them.

Linking web 40 and linking web 41 are aligned with each other, even though they have as a “surface structure” a differently acting basis.

This describes another function, namely that it is impossible for the push member to be released circumferentially in the writing position. If the push button device is displaced forwards the writing instrument is in the writing position, thus the inflexibility of link 40 is responsible for the fact that it cannot be circumferentially moved and removed relative to the inner stop faces e1 and d1 of guide segments D and E of the shaft. Thus is can be prevented that a user may try to release the push button device in the writing position thereby damaging switch rod S or switch tooth Z, which is engaged with the control curves of shaft segments A, B in this position.

The writing instrument may thus be released with respect to the push button device in the retracted position by means a circumferential movement applied to the push button device and by overcoming a latching point. It may be axially reinserted subsequent thereto and will be circumferentially guided by shaft segments D and E. Finally, a barrier for the push member is provided so that it cannot be removed from the shaft by rotation in the writing position in order not to damage the switch rod.

In a favorable case angle β of surface e1 is adapted to ramp 41a. When manufacturing the one-piece part of FIGS. 2 and 3 ramp 41a is continued as ramp 40a also at non-resilient web 40 in the fixed guide portion F of the push button device. This is beneficial for removal from the mold is, however, not critical with respect to function since the non-resilient guide element F with is non-resilient or only slightly resilient link 40 will not yield as much that it might come free relative to the inward measure of surface e1 of FIG. 1a by means of a radial movement.

The above-mentioned gap 45 is favorable for the radial inserting movement if inclined links 42a and 42b are selected. This movement also entails an axial component of motion for the elastically resilient element due to the design according to FIG. 2. Gap 45 should therefore be selected sufficiently wide in order to take the radial inserting movement of latching element C into account with respect to the radial forming depth of shaft segments D and E.

If a visible arrow is provided in an appropriate location on the left-hand side of gap 45 according to FIG. 2, the moving direction for releasing the push member may be indicated to the user, as is apparent from FIG. 3. The buckled arrow depicted therein is not visible in the writing position of push member 10. It is visible outside edge line 8 of shaft 9 in the idle position only and indicates to the user that the push button device may now be removed from shaft 9 by a rotating movement towards the left and axial withdrawal towards the rear for replacement of the refill.

The push member of FIG. 2 has been described as such comprising a push portion L, a body portion K as well as the fixed guide portion F and the elastically resilient latching element C. The other elements of switch rod S and switch tooth Z have already been mentioned as well. Their arrangement at a front portion 50 in the sense of a stop link for the refill M according to FIG. 3 has not yet been mentioned. However, the radially increasing rigidity of switch rod S has indeed been mentioned, which is achieved, in accordance with FIG. 2, by means of a switch rod S radially increasing in width towards the attachment link 50. The switch rod is thus given a greater width in the sense of a greater depth, wherein only switch tooth Z, which requires a radial component of motion, is able to readily perform a circumferential (tangential) and a radial component of motion at the outermost end of switch rod Z controlled by the control curve portions of FIG. 1. The thus described link 50 comprises a flattened portion 50a, which is aligned such that it may be guided past guide links D and E as well as past the residual shaft segments A and B without contacting them. In the assembled state of the writing instrument it is located in front of the foremost shaft segment B and defines the switch rod foot and the stop face for refill M with its end forming a perpendicular angle, as shown in FIG. 3. Push member 10, which is representative of all functions of the writing instrument, has a plurality of functional portions realizing different functions.

(a) Guidance is to be ensured so that the push member will not be circumferentially moveable while switch rod Z is deflected circumferentially, tangentially and/or radially by the axial movement controlled by the control curve portions of the shaft.

(b) The push member also includes the inserting function by means of the elastically resilient latching element located between the fixed guide portion and switch rod S.

(c) The push member also includes the switch rod comprising the switch tooth, wherein the switch rod as such is intended to work with functional precision without any additional elements. The push member must also be produced at low cost while maintaining high precision and accurate switching ability, which requires that switch rod S will not deteriorate due to fatigue even if a low-cost plastic material is used.

(d) Finally, the push member must include a geometry of the switch tooth, which may easily be removed from a mold, which easy removal, however, does not apply to the switch tooth as such only but also to the residual region of the push member, which, apart from the aforementioned requirements, is to be produced at low cost also with regard to the tool technology, i.e. it should be particularly easy to remove from the mold.

These complex problems are taken into account by a push member, which is precisely manufactured at a number of spaced apart functional portions. It comprises an elastically resilient latching zone and a guide portion, which is elastically non-resilient relative thereto. It includes a switch rod portion spaced apart from both elements, which portion is deflected in the idle position of the switch tooth as well as in the writing position of the writing instrument in such a manner that no forces need to be provided, neither in a long-term idle position, nor in the other possibly long-term writing position. The intermediate positions between said two positions are not critical in this respect since they are taken only on a short-term basis, without staying therein for a long period of time and without stressing the switch rod mechanically on a long-term basis. Finally, the removal from the mold is an important criterion of the low-cost production and it is contemplated here that the position and shape of the switch tooth are selected such that a simple injection molding die may be used.

Said die (mold) is depicted separately in FIG. 6. With respect to the mold cavities it is designed such that comprises the negative of the switch tooth shown in FIG. 3 and FIG. 2 in this region as well as in the other regions of the push button device. This may easily be illustrated by an inner representation of the two Figures, shown in part in FIG. 6, without explicitly depicting the remainder of said representation.

The mold is of common nature with respect to the first and second mold halves H1, H2, the only distinctive feature being the separation line T or 70 between the two mold halves. Here the mold separation is contemplated such that the two mold halves define a single plane and that switch tooth Z is arranged in said plane T such that the maximum cross-section 71 is within said plane. The maximum cross-section being the one through which said plane 70 extends. The main axis 100 of the push member is also located within said plane, which axis coincides with axis 99 of FIG. 1.

Exactly because the tooth as such is configured asymmetrically having a plurality of polygon-shaped stop faces zₓ, while still having an oblong oriented shape a maximum cross-sectional area may be determined. The separating plane of the two mold halves runs through said cross-sectional area, which mold halves form said switch tooth. Additionally, switch rod S is also provided, which is configured in such a manner and arranged in the mold, when the mold halves are closed, such that it is oriented either centrally or farther to the left or farther to the right with respect to the mold separating plane T. The boundary positions are such that the switch rod contacts the separating plane at least theoretically, i.e. is arranged either fully within the left mold half or fully within the right mold halve with respect to its width sq, however, given these boundary positions extends perpendicular to plane T so that none of the molds comprises a raised portion within the range of the switch rod or any additional parts as inserts are required. In most cases a partial width S′ will be located in the first mold half H1 and a second partial width S″ will be located in the second mold half H2 in corresponding cavities.

It has also been mentioned with respect to the range of the switch tooth that there is no projection provided at the mold separation. The switch rod and the switch tooth are thus located within a region of the closed mold, which is at least contacted by the separation plane of the two mold halves. Thus it is possible to achieve easy mold separation and low-cost production of the push member.

I claim:

1. A shaft for a writing instrument and for receiving a push button device (10) having a switching element (S,Z), said shaft being made of a permanently shapeable material and having a front end, wherein said push button device is displaced far backwards from said front end (writing end), said shaft (9) being provided with a number of control curve portions (a3,b1,b3,a2; A2) for cooperation with said switching element (S, Z) and for reaching a first shift position (writing position) located in a first axial position and a second shift position (idle position) located in a second axial position being displaced backwards relative to the first shift position, characterized in that said control curve portions
(a) are made of the same material as an axial portion of said shaft (9), in which portion said two axial shift positions are located;
(b) are defined by at least one shaft segment (A; A1,A2,A3; B,B1,B2) reshaped in the radial direction by a forming force, which shaft segment, in a first portion of the segment, comprises a region of deformation (u), such as a bending or inflexion line being deformed radially inwardly, wherein the reshaping or deformation of said shaft segment is effected at least along said region of deformation for defining the control curve portion projecting radially from said shaft (9) and extending at least in the axial direction.

2. Shaft as defined in claim 1, wherein at least two shaft segments (A; B) are provided.

3. Shaft as defined in claim 1, wherein a separating line (t) as a second portion is created by the radial deformation on said at least one reshaped shaft segment (A; B), along which separating line (t) an at least partial separation of said radially reshaped segment from the residual shaft (9) is effected for cutting free or exposing said second portion.

4. Shaft as defined in claim 1, wherein at least two shaft segments (A; B), for defining control curve portions, are radially deformed and arranged on said shaft axially offset relative to each other.

5. Shaft as defined in claim 1, wherein at least one region of deformation (u), in particular a deformation line (b1,b3), is buckled or bent.

6. Shaft as defined in claim 1, wherein the material is metal.

7. Shaft as defined in claim 1, wherein said at least one shaft portion (A; B) in its radial deformation (u) is produced by use of a deep-drawing method, in particular in combination with claim 3, as a combined cutting and bending method, under formation of at least one bending line (u) and at least one separating line (t).

8. Shaft as defined in claim 1, wherein the rear portion is the last third part, in particular the last fourth part, of the length of said shaft.

9. Shaft as defined in claim 1 or 3, wherein at least one region of deformation (u) serves as a control curve portion (a3) for said switching element (S,Z), along which a switch tooth glides upon axial actuation of said push button device (10), wherein especially at least one separating line (t) of a shaft segment (A,B) is arranged and oriented such that it is not contacted by said switch tooth (Z) upon axial actuation of said push button device (b1) or serves as an abutment for said tooth without any substantial relative movement between switch tooth and separating line (al).

10. A shaft portion having a substantially tubular geometry with considerable axial extension for use in the production of a writing instrument in combination with a push button device having an elastically deflectable switch rod and a switch tooth (Z) arranged on said rod, wherein
at least one segment (A,B,C,D) of said shaft portion (9) is radially reshaped for defining at least one portion of a control curve for said switch tooth (Z) provided on said switch rod of said one-piece push button device (10);
said at least one segment (A,B,D,E) is comprised of the same material as said shaft portion (9);
the radial deformation or reshaping of said segment relative to said shaft portion is provided or effected along at least one region of deformation (u).

11. Shaft portion as defined in any one of the preceding claims, wherein at least two radially reshaped segments (A,A2,A3; B,B1) are provided and wherein one of said segments (B1) has a greater radial extension, based on the residual dimension of said shaft portion, relative to said other segment (A3,A2).

12. Shaft (portion) as defined in claim 1 or independent claim 10, wherein at least one segment has an inclined surface (e1,A2) extending in the axial, circumferential and radial directions of said shaft portion for displacing said switch tooth (Z) by at least one radially oriented component upon a switching movement, which is caused by an axial movement of said push button device.

13. Shaft portion as defined in claim 10, wherein said region of deformation (u) is a buckling or inflexion line.

14. Shaft portion as defined in claim 11, wherein the radial extension has a greater depth in the direction towards the interior of said shaft portion.

15. A writing instrument having a shaft (9), particularly as defined in any one of the preceding claims, and a push member (K,L; 10) especially formed in one piece (one-part or integrally), which push member comprises a push portion (L), a body portion (K,50) and a switch rod portion (S) extending from said body portion in the axial direction and having a switch tooth (Z) protruding radially from said switch rod, said switch tooth (Z):
(a) is displaced within said shaft (9) by at least one small segment (A,B) of said shaft (9), said segment being reshaped in the radial direction, said displacement taking place upon actuation of said push member (10) in particular in at least one of the circumferential, tangential and radial directions; or
(b) comprises two axially spaced apart stable positions corresponding to the writing position and the retracted position of said writing instrument, wherein said tooth (Z), in both positions, occupies the same at least circumferential (tangential) position only axially displaced; or
(c) is arranged on said switch rod portion in such a way and has such a circumferential (tangential) extension (z6,z2) and shape that a centre plane (70), which extends in parallel to a centre axis (100) of said push member, lies at an axial front end portion (z3,z1) as well as at an axial rear end portion (z7) of said switch tooth (Z) within said switch tooth.

16. Shaft as defined in claim 1 or 10 or a writing instrument as defined in claim 15, wherein the deformation is effected radially inwards in a direction towards a centre (axis) of said shaft (9).

17. Writing instrument as defined in claim 15, wherein said switch tooth (Z), when inserted in said shaft, abuts an inner wall of said shaft in order to follow said control curve portions on said at least one reshaped shaft segment (A, B) as precisely as possible.

18. Writing instrument as defined in claim 17, wherein the abutment on said inner wall is effected by an at least one-sided slope (z4, z5) of the surface of said switch tooth in order to be able to also slide along a surface (A2) being inclined in the radial direction and to be pressed against said surface.

19. Writing instrument as defined in claim 17, wherein said inserted switch tooth (Z) receives a slight radial bias.

20. Push button device for insertion into a shaft as defined in claim 1 or claim 10 having a body portion (K,50), a switch rod (S) extending at least in the axial direction and a switch tooth (Z) arranged on said rod, being elastically deflectable from its idle position via said switch rod (S), said switch tooth protruding radially from said switch rod, wherein said switch tooth (Z) comprises a plurality of cross-sectional areas extending in the axial direction and having different areas and wherein a cross-sectional area having a maximum area (71) defines a plane (70), which in the production of said push button device, between two mold halves (H1,H2) in a plastic injection molding method, is the separating plane (T) of said mold halves or comes to lie directly in said separating plane.

21. Push button device as defined in claim 20, wherein said push member is formed in one piece or integrally from a continuous plastic material in the injection molding method.

22. Push button device as defined in claim 20, wherein said switch rod (S) has an axial length and a circumferential (tangential) width and is connected to said switch tooth (Z) in such a manner that an extension of said switch rod, perpendicular to said plane (70) of the maximum cross-sectional area and relative to the maximum cross-sectional area (71) of said switch tooth (Z)—which corresponds to the separating plane (T) of the mold halves upon removal from the mold—on the one or other side of said areas (71,T), corresponds maximally to the width (sq) of said switch rod.

23. A push member for insertion into a shaft as defined in claim 1 or claim 10, having a body portion (K,50), a switch rod (S) extending at least in an axial direction and a switch tooth (Z) arranged on said rod and elastically deflectable from its idle position via said switch rod (S), said switch tooth protruding radially from said switch rod, wherein
an elastically resilient latching element (C; 41,41a,42a,42b,43) is arranged on said body portion (K,50), which latching element comprises a first surface structure (41,42) facing said shaft, for exerting a radially oriented force onto said resilient latching element (C) upon a circumferential relative pivot movement of said shaft relative to said push member, in order to free and axially remove said push member from said shaft (9).

24. Push member as defined in claim 23, wherein a guide portion (F) is also arranged on said body portion (K,50), said guide portion having a further surface structure (40) continuing the first surface structure and being axially spaced from said resilient latching element (C), which structure is suitable for limiting a circumferential movement of said push member at protuberances (D,E) provided on said shaft so that applying a circumferentially oriented force on said push member or shaft does not cause said guide portion (F, 40) to come free.

25. Push member as defined in claim 23, wherein said elastically resilient latching element (C) is arranged on said body portion (K) between said switch tooth (Z) and a push portion (L) of said push member.

26. Push member as defined in claim 23, wherein said elastically resilient latching element (C) comprises two inclined links (42a,42b) being arranged and oriented such that there remains a gap (45) between said latching element (C) and a non-elastically resilient guide portion (F) for a radial inward movement and an axial deflection of said latching element (C) under the influence of a radial force due to a circumferential relative pivot movement.

27. Push member as defined in claim 23, wherein said first surface structure is defined by a link (41), especially having a ramp (41a) running along said link on one side for cooperation with a respective counter-slope (e1) provided on said shaft (9).

28. Push member as defined in claim 24, wherein said first and further surface structures (41, 40) are configured identical in the axial direction, however, only said first one being elastically resilient in the radial direction together with said latching element (C).

29. Push member as defined in claim 23, wherein said first surface structure (41,43) comprises an edge (43,43v) oriented transversally to the axial direction for cooperation with said shaft segments (9, 8) and for applying a radial force to said latching element (C) in order to insert said push member into said shaft (9).

30. A push button device for insertion into a shaft as defined in claim 1 or claim 10, having a body portion (K,50), a switch rod (S) extending at least in an axial direction and a switch tooth (Z) being arranged on said rod and elastically deflectable from its idle position via said switch rod (S), said switch tooth protruding radially from said switch rod, wherein said switch tooth (Z) deflectable from its idle position, upon insertion of said push button device into said shaft comprises two stationary positions, a rear position as an idle position of said writing instrument and an axially forward position as a writing position of said writing instrument, and wherein said two positions of said switch tooth (Z) do not diverge from each other in the tangential (circumferential) direction.

31. Push button device as defined in claim 30, wherein within the range of said switch rod, along the axial extension thereof, no fixed support is arranged on said body portion (K) enabling engagement by means of contact within the range of the radial or tangential movement of said switch rod in order to control the switching accuracy.

32. Push button device as defined in claim 30, wherein said switch tooth (Z) provided on said switch rod (S), when in its idle position and not inserted into said shaft, lies substantially in a centre plane (97), which centre plane runs through a main axis (100) of said push member and through said switch rod (S) in an at least contacting manner.

33. Push button device as defined in claim 30, wherein said switch rod (S) has elasticity or resilience in the radial direction and in the tangential (circumferential) direction and
(a) said elasticity in the radial direction is less than that in the tangential direction; or
(b) said resilience in the radial direction is less than the resilience in the tangential direction.

34. Push button device as defined in claim 30, wherein said two positions of said switch tooth (Z) do not diverge from each other neither in the radial direction nor in the tangential (circumferential) direction.

35. A writing instrument comprising a shaft, having a front end and being made of a permanently shapeable material, for receiving a push button device (10), which is positioned far backwards from said front end (writing end), and a switch rod (S) arranged on said push button device and being elastically deflectable from an idle position, wherein a number of control curve portions (a3,b1,b3,a2; A2) is provided on or in said shaft (9) for cooperation with a switching element (S,Z) provided on said elastically deflectable switch rod (S) of said push button device (10) and for providing
(i) a first shift position (writing position) of said push button device (10) located in a first axial position;
(ii) a second shift position (idle position) of said push button device (10)—displaced backwards relative to the writing position—located in a rearwards displaced second axial position;
characterized in that said shaft (9) is formed of a metallic material or of a comparable other material, such as a hard plastic material suitable for bending or other permanently shapeable material, and said push button device (10), at least in a region of a foot portion of said switch rod (S), is made of an elastically deflectable plastic material.

36. A writing instrument comprising a shaft (9), in particular as defined in any of the preceding claims 1 to 14, having a switch tooth (Z) as a switching element of a substantially one-piece push member (10), wherein said switching element
(a) is displaced by at least one radially reshaped segment (A,B) of said shaft (9) upon actuation of said push member (10) in the longitudinal direction within said shaft (9); and/or
(b) comprises two axially spaced apart stable positions corresponding to the writing position and the retracted position of said writing instrument, respectively, wherein said switch tooth (Z), in both positions, occupies the same at least circumferentially oriented (tangential) position relative to said shaft (9), only axially displaced.

37. A push button device for insertion into a writing instrument as defined in claim 35 or 36 having a body portion (K,50), a switch rod (S) extending at least in the axial direction and a switch tooth (Z) as a switching element being arranged on said rod and elastically deflectable from its idle position via said switch rod (S), said switch tooth protruding radially from said switch rod, wherein said switch tooth (Z) being deflectable from its idle position, upon an insertion of said push button device into said shaft, comprises two stationary positions, a rear position as an idle position of said writing instrument and an axially forward position as a writing position of said writing instrument and wherein the two positions of said switch tooth (Z) do not diverge from each other substantially in the tangential (circumferential) direction.
